(19) United States
(12) Patent Application Publication
(10) Pub. No.: US 2025/0044487 A1
(43) Pub. Date: Feb. 6, 2025

(54) FOCUS-TUNABLE LIQUID LENS WITH BELLOW-LIKE WALL CONTAINER WALL

(71) Applicant: OPTOTUNE SWITZERLAND AG, Dietikon (CH)

(72) Inventors: Erik HEBESTREIT, Dietikon (CH); Alan CORTIZO, Zug (CH)

(73) Assignee: OPTOTUNE SWITZERLAND AG, Dietikon (CH)

(21) Appl. No.: 18/718,037

(22) PCT Filed: Dec. 9, 2022
(86) PCT No.: PCT/EP2022/085211

§ 371 Date: Jun. 9, 2024

(30) Foreign Application Priority Data
Dec. 9, 2021 (WO) PCT/IB2021/061529

(51) Int. Cl. G02B 3/14

(52) U.S. Cl. CPC G02B 3/14

(57) ABSTRACT

The invention relates to a focus-tunable liquid lens (100) comprising a container (6) filled with a transparent liquid, wherein the container (6) comprises container components: a) an elastically deformable transparent membrane (4) arranged on a first side of the container (6), b) a transparent window element (5) arranged opposite the membrane (4) on a second side of the container (6), particularly wherein the window element (5) forms a transparent bottom portion of the container (6), c) an elastically deformable circumferential wall portion (1) connecting the window element (5) and the membrane (4) along a contour of the wall portion (1), the wall portion (1) limiting a radial extension of the container (6) along a radial direction of the lens (100), d) a lens shaping element connected to the membrane (4), wherein the lens shaping element has a circumferential aperture comprising an optical axis (OA) of the lens (100), wherein the aperture encloses a lens area of the membrane (4) within which a shape of the membrane (4) may be adjusted by actuating the lens shaping element relative to the window element (5) by means of an actuation force for adjusting a refractive power and/or other optical properties such as astigmatism, a prism and/or another optical aberration of the lens, wherein the wall portion (1) is formed as a bellows, particularly such that upon actuation of the lens shaping element the radial extension of the container (6) is maintained or at least reduced.

The invention relates a focus-tunable liquid lens with bellow-like wall container wall for minimizing radial deformation of the container upon actuation of the lens.

Liquid lenses are known in the art. The term liquid lens in the context of this specification particularly relates to lenses having a container that encloses a transparent liquid in a lens volume, wherein said container comprises on a first side of the container at least a first membrane that is arranged such that it can be actuated by a movable lens shaping element. The lens shaping element comprises a circumferential clear aperture within which a lens area of the membrane is enclosed. Upon actuation of the movable lens shaping element, the membrane adjusts its curvature in the lens areas, such that for example the lens adjusts its convex or concave shape and thus its refractive power.

Some of the liquid lenses might have an elastically deformable wall portion that limits the lens volume of the container along its circumferential portion, i.e. the wall portion extends circumferentially around the lens volume. When the lens shaping element pushes towards the lens volume a pressure inside the container increases and the wall portion experiences a radial force that causes said wall portion to radially bulge.

The term radially particularly refers to the direction that extends orthogonally away from the optical axis or a z-axis of the lens.

When the lens shaping element pulls away from the lens volume, the wall portion might bulge inward the lens volume. Any radial bulging of the wall portion however translates in an increase in actuation force (in comparison to non-bulging wall portions).

In the art elastic wall portions are known that have a sleeve- or tube-like shape. Upon actuation of the lens, the sleeve is stretched or compressed by the actuation force. However, as stretching exhibits non-linear extension and compression characteristics for the actuation force this mechanism limits the travel range or stroke of the lens as the actuation forces become comparably high when the sleeve is stretched beyond the linear force regime. In the other direction the sleeve cannot be compressed without limitation.

An object of the present invention is to provide a liquid lens that overcomes the problem of the high actuation force. The object is achieved by the device having the features of claim 1.

Advantageous embodiments are described in the subclaims.

According to claim 1 a focus-tunable liquid lens comprises a container filled with a transparent liquid, wherein the container particularly encloses a lens volume, wherein the container comprises at least the following components:
a) an elastically deformable, transparent membrane arranged on a first side of the container,
b) a transparent window element arranged opposite the membrane on a second side of the container, particularly wherein the window element forms a transparent bottom portion of the container,
c) an elastically deformable, particularly circumferential wall portion, particularly directly connecting the window element and the membrane, particularly at a circumferential portion of the container, the wall portion limiting a radial extension of the container along a radial direction of the lens,
d) a lens shaping element connected to the membrane, wherein the lens shaping element has a circumferential aperture comprising an optical axis of the lens, wherein the aperture encloses a lens area of the membrane within which a shape of the membrane may be adjusted by actuating the lens shaping element relative to the window element by means of an actuation force for adjusting a refractive power and/or other optical properties such as astigmatism, a prism and/or another optical aberration of the lens,
characterized in that
the wall portion is formed as a bellows, particularly such that upon actuation of the lens shaping element the radial extension of the container is maintained or at least reduced compared to non-bellows-shaped wall portions.

The term “elastically deformable” particularly refers to a distensible characteristic of the elastically deformable component.

A coordinate system might be associated to the lens, wherein the coordinate system may be a Cartesian or a cylindrical coordinate system. The z-axis in both cases extends essentially along the optical axis of the lens, particularly as long there is no prism involved in the optical properties of the lens. When the lens is in equilibrium state, i.e. when no actuation force is applied to the lens, the z-axis particularly extends orthogonally to a side of the window element that faces toward the lens volume.

The radial direction(s) of the lens, such as the x- and y-direction extend orthogonally to the z-axis of the lens. The directions associated to the lens correspond to the container as well.

It is noted that the membrane and the lens area might have a non-circular and even a non-round shape along a plane that extends essentially orthogonal to z-axis of the lens. The same applies to the window element and other components of the lens, such as the lens shaping element, the wall portion.

According to another embodiment of the invention, the z-axis corresponds to the optical axis of the lens.

The wall portion comprises a thickness that particularly is measured straight across the contour of the wall portion. The thickness of the wall portion may vary along the contour of the wall portion.

According to another embodiment of the invention, the contour is formed by a surface of the wall portion that faces toward the liquid and a surface of the wall portion that faces in the opposite direction, particularly when the lens is in the equilibrium state.

According to another embodiment of the invention, the contour of the wall portion adopts a zig-zig shape.

The shape of the membrane particularly refers to a curvature and/or a contour of the membrane along optical axis, e.g. a convex or a concave shape as well as more complex shapes.

According to another embodiment of the invention, the wall portion comprises a plurality of annular bend portions extending along a circumferential extension direction, i.e, particularly circumferentially around the wall portion, wherein each bend portion comprises a bend of the bellows at which the wall portion bends in a predefined direction.

The predefined direction toward which the wall portion bends upon actuation may be imprinted during the manufacturing process of the wall portion. A suitable manufacturing process may comprise injection molding.

According to another embodiment of the invention, the wall portion comprises a plurality of annular folding segments extending between, particularly connecting the bend portions, wherein adjacent folding segments adopt an angle, particularly wherein each angle has a bend enclosed between the adjacent folding segments, wherein the bend forms the angle apex.

According to another embodiment of the invention, the folding segments are stiffer than the bending portions, particularly such that upon actuation of the lens shaping element the bellows bends only or predominantly at the bending portions, particularly such that upon actuation of the lens shaping element, the angles between folding segments change and particularly wherein a segment length remains unaltered.

The segment length is particularly oriented and measured along the wall portion contour in a direction pointing from the window element towards the membrane.

According to another embodiment of the invention, the wall portion comprises fibers, particularly fibers that have a higher tensile elasticity than a matrix material of the wall portion within which the fibres are embedded, wherein the fibres are arranged in an annular fashion around the optical axis circumferentially in the contour of the wall portion, particularly such that the fibers increase a stiffness along a circumferential direction of the wall portion.

It is noted that the wall portion may define three locally varying directions. A first direction relates to a circumferential direction of the wall portion. The circumferential direction particularly corresponds to an angular direction of the wall portion.

Orthogonally to the circumferential direction of the wall portion and extending within the contour of the wall portion, an extension direction of the wall portion may be defined. Said direction particularly points along a zig-zig cross-section along the optical axis of the bellows. Along this direction the length of the segments may be measured.

A third direction, that extends orthogonally to the circumferential and the extension direction of the wall portion, particularly points along the thickness of the wall portion. Along this radial direction the thickness of the wall portion may be measured.

It is noted that particularly the extension direction and the radial direction in direction depending on the contour of the bellows, wherein the contour may be altered by applying an actuation force to the lens.

According to another embodiment of the invention, the angles formed by particularly directly adjacent, and thus adjoining folding segments alternatingly open toward a side of the container facing the liquid and a side facing away from the liquid.

According to another embodiment of the invention, each bend is formed by at least one recess extending circumferentially around the optical axis in the wall portion, particularly wherein the at least one recess locally reduces a wall thickness of the wall portion.

This embedment allows for achieving low actuation forces combined with a comparably constant radial extension of the container.

According to another embodiment of the invention, a first group of recesses of the plurality of recesses is arranged on a side of the wall portion facing away from the liquid in the container, wherein a second group of recesses of the plurality of recesses is arranged on a side of the wall portion facing toward, e.g. being exposed to the liquid in the liquid in the container.

According to another embodiment of the invention, the recesses from the first group are arranged alternatingly with the recesses of the second group along the contour of the wall portion.

According to another embodiment of the invention, the recesses of the first group and the recesses of the second group are arranged at the same position along the contour of the wall portion, thereby pairwise forming a bend of the bellows.

According to another embodiment of the invention, the angles formed by particularly directly adjacent or adjoining folding segments alternatingly open toward a side of the container facing the liquid and a side facing away from the liquid.

This embodiment allows for an essentially zig-zag shaped bellows.

According to another embodiment of the invention, the wall portion comprises a first and a second connecting segment, wherein the first connecting segment connects the wall portion with the membrane and the second connecting segment connects the wall portion with the window element, wherein the connecting segments are connected via one bend of the bends to a directly adjacent or adjoining folding segment, wherein a first angle enclosed by the first connecting segment and the directly adjacent or adjoining folding segment opens to the same side in terms of facing towards or away from the liquid as the angle enclosed by two folding segments adjacent or adjoining to said first angle and/or wherein a second angle enclosed by the second connecting segment and a directly adjacent or adjoining folding segment opens to the same side as the angle enclosed by two folding segments adjacent or adjoining to said second angle.

According to another embodiment of the invention, each folding segment comprises a segment length extending along the contour of the wall portion, wherein the segment length of the folding segments is different for different folding segments.

The segment length has been defined in the context of a previous embedment.

This embodiment allows for a wall portion that folds uniformly for each enclosed angle upon actuation, and particularly not segment-wise in series or essentially in series.

According to another embodiment of the invention, adjacent folding segments have pairwise identical length and may differ in length for different pairs.

According to another embodiment of the invention, a stiffness of the bending portions is different for different bending portions, particularly wherein the stiffness is adjusted such that upon actuation of the lens, the bends of the bending portions change by the same amount, particularly wherein angle openings change by the same amount such that the wall portion folds equally and uniformly at all bends.

According to another embodiment of the invention, each folding segment comprises segment thickness, wherein the thickness of the folding segments is bigger than the bending portions, particularly bigger than a thickness of the wall portion at the recesses.

The thickness of the folding segments is the same as the thickness of the wall portion at the specific segment.

According to another embodiment of the invention, the wall portion is integrally formed by an elastically deformable compound such as silicone or PDMS. PDMS relates to Polydimethylsiloxane (CAS-Nr: 63148-62-9).

According to another embodiment of the invention, the thickness of the folding segments is between 300 μm and 700 μm and wherein the thickness of recesses is between 100 μm and 300 μm.

According to another embodiment of the invention, the wall portion has a larger opening on the first side of the container than on the second side of the container.

This allows for wall portion that does not obstruct the optical path of the lens, while the wall portion might be in a compressed state.

According to another embodiment of the invention, a stiffness of the wall portion along a circumferential direction of the wall portion is higher than a stiffness of the wall portion along an extension direction of the wall portion as well as a stiffness of the wall portion along a radial direction to the wall portion.

The directions relating to the wall portion have been elaborated in previous embodiment in the specification.

The different stiffness of the wall portion may be achieved by means of a wall portion comprising a material that exhibit non-isotropic or anisotropic stiffness.

The anisotropic material properties may be achieved by a corresponding injection molding process for the wall portion, where injection of the material in a molding form is such that the solidified wall portion exhibits said anisotropic property.

The embodiment allows for a wall portion that may be bent using low actuation forces, while any bulging of the wall portion is greatly reduced or prevented.

According to another embodiment of the invention, the lens shaping element can be moved relatively to the window element for adjusting the refractive power of the lens, particularly wherein the window element is connected to a housing or fixing member of the lens, particularly wherein the lens shaping element is connected to an actuator that is configured to move the lens shaping element relatively to the window element.

According to another embodiment of the invention, the window element is a rigid window element, particularly wherein the window element is made of glass or a transparent polymer, particularly wherein the window element comprises a refractive power or wherein the window element is a planar plate-like window element having two planar sides facing towards and away from the liquid, more particularly wherein the window element is a solid lens.

According to another embodiment of the invention, the window element is or comprises a second distensible membrane, particularly wherein upon actuation of the lens shaping element said second membrane adjusts its curvature along the optical axis of the lens.

According to another embodiment of the invention, the lens shaping element is elastically deformable at the circumferential aperture along the optical axis, particularly such that aberrations can be compensated by locally adjusting an axial position of the lens shaping element along its circumferential aperture.

Particularly, exemplary embodiments are described below in conjunction with the Figures. The Figures are appended to the claims and are accompanied by text explaining individual features of the shown embodiments and aspects of the present invention. Each individual feature shown in the Figures and/or mentioned in said text of the Figures may be incorporated (also in an isolated fashion) into a claim relating to the device according to the present invention.

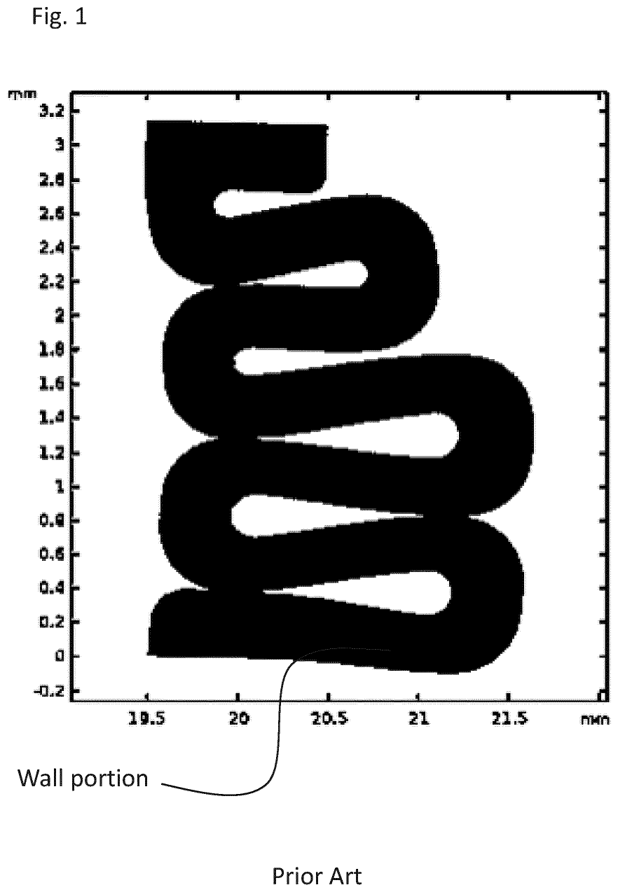

FIG. 1 Prior art of a compressed elastic wall portion of a liquid lens;

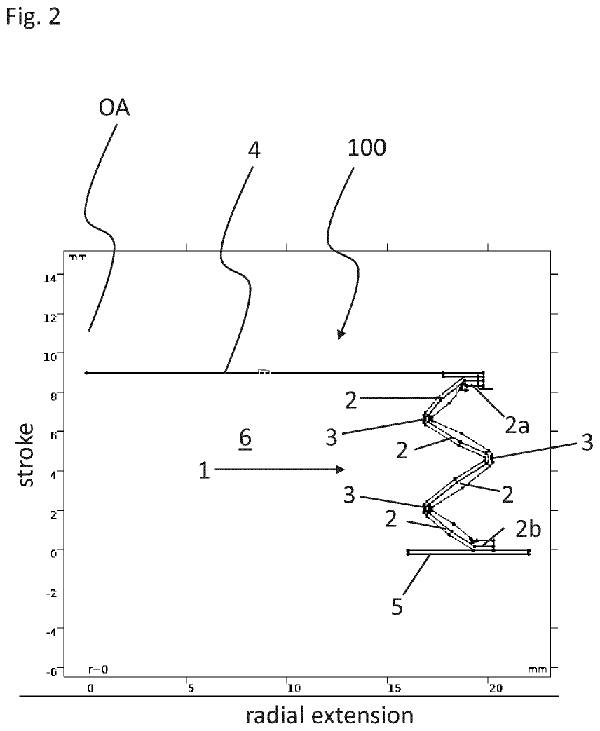

FIG. 2 cross-sectional view of a liquid lens with a wall portion according to the invention;

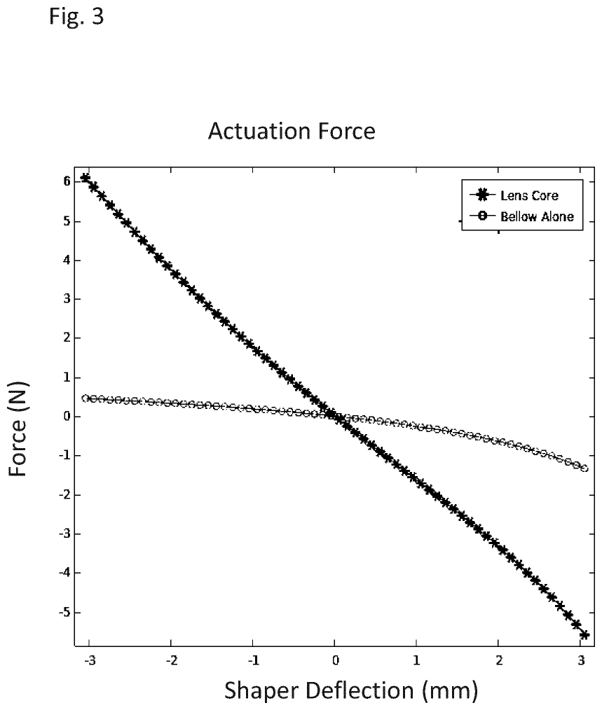

FIG. 3 graph of actuation forces in a lens according to the invention;

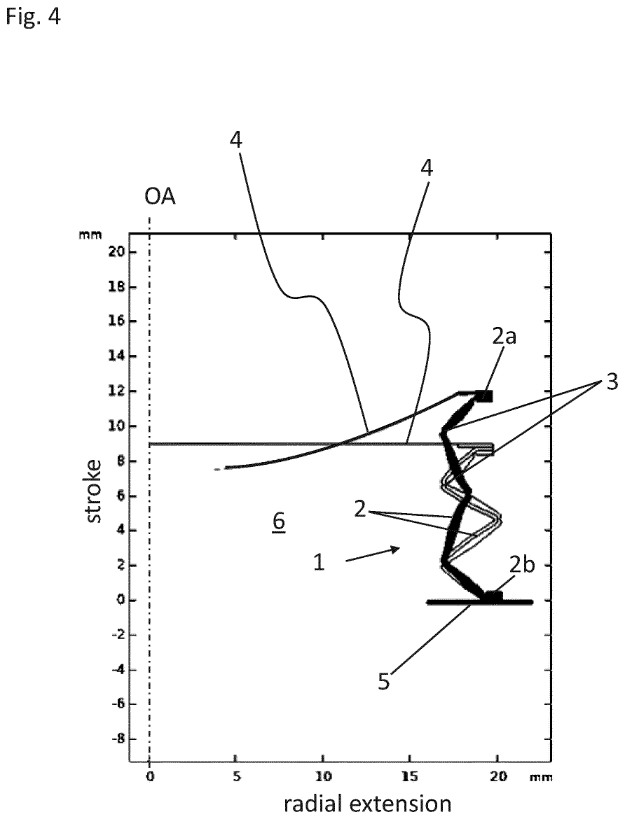

FIG. 4 cross-sectional view of a liquid lens with a wall portion according to the invention in an extended state;

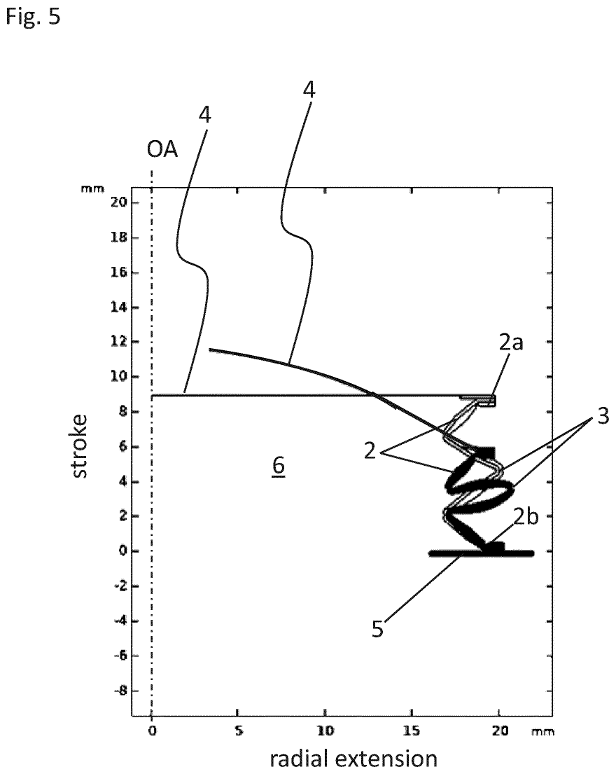

FIG. 5 cross-sectional view of a liquid lens with a wall portion according to the invention in a compressed state;

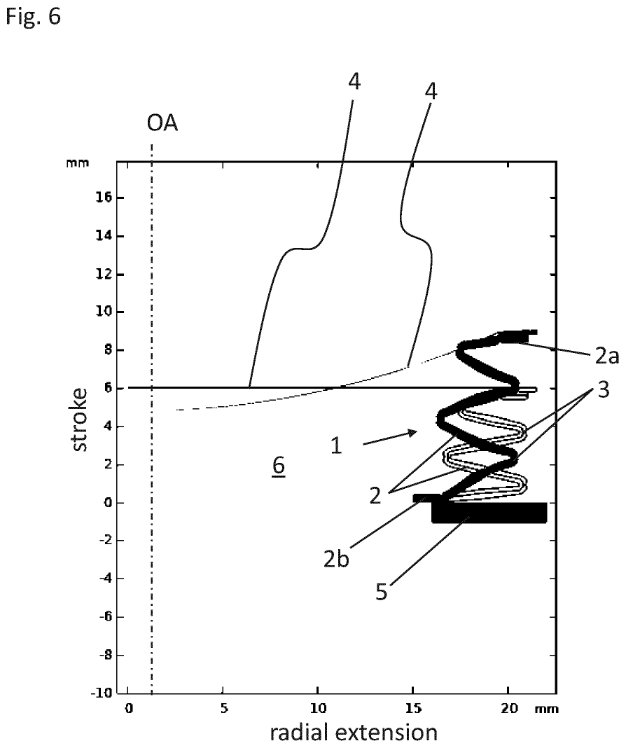

FIG. 6 cross-sectional view of a liquid lens with a wall portion according to the invention in an extended state;

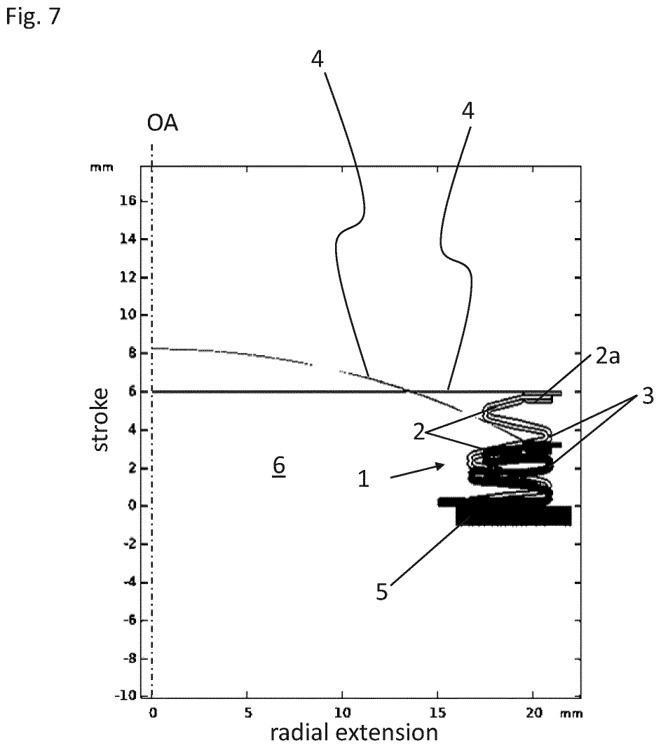

FIG. 7 cross-sectional view of a liquid lens with a wall portion according to the invention in a compressed state;

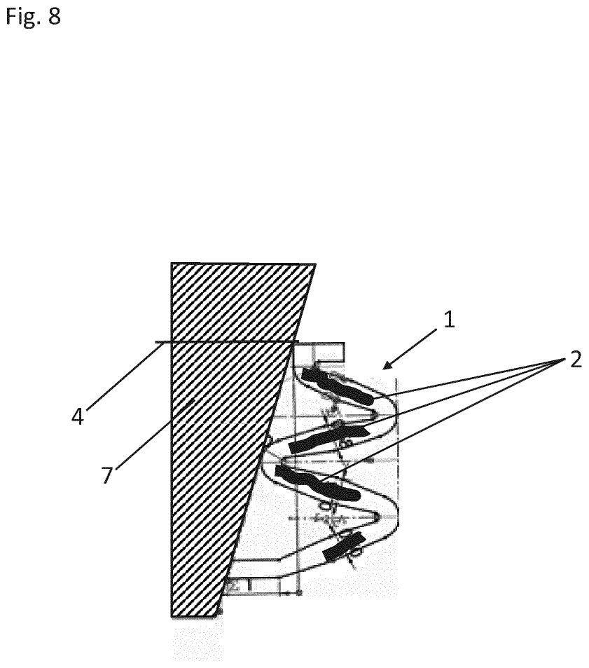

FIG. 8 cross-sectional view of a liquid lens with a wall portion according to the invention in relation to the light cone;

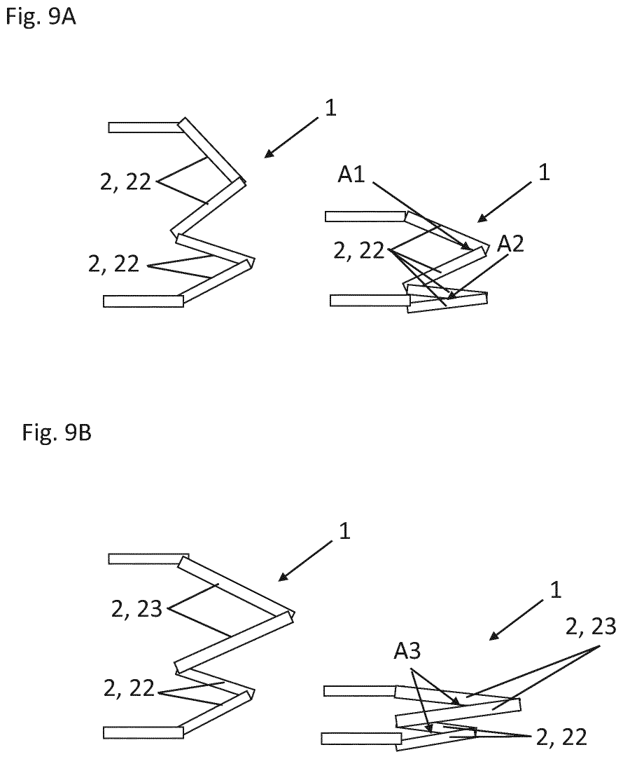

FIG. 9 cross-sectional views of a liquid lens with a wall portion having varying folding segments;

In FIG. 1. A simulated shape of a folded elastic wall portion in a compressed state of a liquid lens is shown. The wall portion meanders randomly and high surface stress forces are generated at the turns of the wall. This situation causes a high energy consumption for actuation of the liquid lens.

The sleeve-like wall portion has a constant thickness and isotropic material properties. Horizontal axis (X) depicts the radial displacement of the wall portion; Vertical axis (Y) depicts the wall portion along the optical axis or z-axis of the lens.

In FIG. 2 an exemplary embodiment of the wall portion 1 according to the invention is schematically depicted. The illustration in FIG. 2 shows a cross-sectional view along the z-axis/optical axis of the lens 100. On the z-axis, the extension of the lens 100 between an upper end 2a of the wall portion 1 and a lower end 2b of the wall portion 1 is shown. The lower end 2b of the wall portion 1 is attached at position 0 mm along the z-axis to a window element 5, wherein the upper end 2a is attached to a distensible membrane 4 of the liquid lens 100. The height of the wall portion 2 extends to about 9 mm. The optical axis OA is plotted as a broken line extending from a radial distance of 0 mm apart along the z-axis. On the x-axis the radial extension of the liquid lens 100 is depicted. The liquid of the lens 100 is comprised in a container 6 that is formed by the window element 5, the wall portion 1 as well as the membrane 4.

The wall portion 1 in FIG. 2 comprises a plurality of folding segments 2 that are interconnected by bend portions 3. Each folding segment 2 is inclined either toward an inside of the liquid lens 100, i.e. toward the container 6 or away from the container 6. These folding segments 2 contribute to the zig-zag shape of the wall portion 1.

The folding segments 2 are interconnected by bend portions 3 each having a bend in form of a recess in the wall portion 1 such that a thickness across the wall portion 1 is reduced. By reducing the thickness of the wall portion a bending moment is reduced, when the wall portion 1 is stretched or compressed away from the equilibrium position that is shown in FIG. 2.

In turn the folding segments 2 have an increased thickness and/or stiffness across the wall portion as compared to the bend portions 3 such that they are not prone to form a bend upon actuation of the membrane 4.

At the upper end 2a of the wall portion 1—formed as the last folding segment—the wall portion comprises a first connecting segment 2a that connects the wall portion 1 with the membrane 4.

At the lower end 2b, the wall portion 1 comprises a second connecting segment 2b that connects the wall portion 1 with the window element 4. The window element 4 may be made of a transparent massive material such as glass or a transparent polymer.

In FIG. 3 a diagram is shown that sets in relation an actuation force with a shaper deflection of the liquid lens 100. The shaper deflection is in essence a height measure (also referred to as stroke) for a motion of the actuator that actuates the membrane relative to the window element up and/or down.

This actuation force is almost linear over a range between −3 mm to +3 mm (cf. line with “x”). In the same graph there is shown the actuation force necessary to adjust solely the bellows-shaped wall portion (cf. line with “o”). Only in extended positions between 2 mm to 3 mm the bellow alone contributes a significant amount of force that needs actuation.

Wall portions known in the art exhibit a much steeper curve for the wall portion which in turn translates to a higher contribution to the total actuation force needed to actuate the liquid lens.

FIG. 4 shows two states of an embodiment of the wall portion 1 according to the invention. The first state is also depicted in FIG. 2 and is therefore not detailed again in relation to FIG. 4. In addition to the wall portion 1 of FIG. 2, which depicts the equilibrium state, i.e. the state in which no actuation force is exerted on the membrane 4, FIG. 4 depicts the wall portion 1 in an extended state as well, in which the height of the wall portion 1 is increased by about 3 mm. Such motion may be achieved by pulling the membrane 4 away from the window element 5 or vice versa. The membrane 4 adopts a concave state and the wall portion 1 adopts a more extended state along the optical axis OA. Throughout the wall portion 1 almost no significant surface stress may be observed, as the bend portions 3 and the folding segments 2 are designed such that such surface stress is reduced, e.g. by having differing wall thickness and stiffness.

The reverse situation is shown in FIG. 5, where the wall portion 1 is compressed. Similar to FIG. 4, no significant surface stress may be observed.

Further, according to the invention, a radial extent of the lens is not altered by compressing or extending the wall portion, which allows for a small building space of the lens.

In FIGS. 6 and 7 a different embodiment of the wall portion 1 is shown, wherein the wall portion 1 comprises one more folding segment 2 than the wall portion 1 depicted in FIGS. 2, 3 and 4. This allows for an increased stroke of the liquid lens 100.

In FIG. 8 the consideration of a light cone 7 defining a field of view through the lens 100 is implemented in the design of the wall portion 1. For this reason, the wall portion 1 comprises folding segments 2 of different length. At the bottom of the liquid lens 100, i.e. at the window element 5, a length of the folding segments 2 is greater than a length of folding elements 2 that are arranged closer to the membrane 4 of the liquid lens 100. This way, upon compression of the wall portion 1 and also in other states of the wall portion 1, the light cone 7 remains unobstructed by any of the folding segments 2 of the wall portion 1, which allows an increased field of view of a liquid lens 100.

Yet another design of the wall portion 1 is depicted in FIG. 9. In FIG. 9A the wall portion 1 comprises folding segments 22 that have pairwise the same length, wherein in FIG. 9B the folding segments 22, 23 have pairwise different lengths.

Depending on which design is used, the collapsing of the wall portion has 1 a different characteristic. For example, the wall portion 1 shown in FIG. 9A in the compressed state adopts different angles A1, A2 between the folding segments 22. As can be seen, an angle A2 between the two lower folding segments 22 is much steeper than the angle A1 between the upper to folding segments 22. It is noted that the first and the second connection segment are not accounted for in this consideration.

In contrast, in FIG. 9B the angle A3 enclosed by the folding segments 22, 23 is identical. This is due to the pairwise differing lengths of the folding segments 22, 23.

### REFERENCE SIGNS

100 liquid lens
1 wall portion
2, 22, 23 folding segment
2a first connecting segment
2b second connecting segment
3 bend portion/bend
4 membrane
5 window element
6 container/liquid
7 light cone
A1, A2, A3 angles between folding segments
OA optical axis

1. A focus-tunable liquid lens (100) comprising a container (6) filled with a transparent liquid, wherein the container (6) comprises container components:
a) an elastically deformable transparent membrane (4) arranged on a first side of the container (6),
b) a transparent window element (5) arranged opposite the membrane (4) on a second side of the container (6), particularly wherein the window element (5) forms a transparent bottom portion of the container (6),
c) an elastically deformable circumferential wall portion (1) connecting the window element (5) and the membrane (4) along a contour of the wall portion (1), the wall portion (1) limiting a radial extension of the container (6) along a radial direction of the lens (100),
d) a lens shaping element connected to the membrane (4), wherein the lens shaping element has a circumferential aperture comprising an optical axis (OA) of the lens (100), wherein the aperture encloses a lens area of the membrane (4) within which a shape of the membrane (4) may be adjusted by actuating the lens shaping element relative to the window element (5) by means of an actuation force for adjusting a refractive power and/or other optical properties such as astigmatism, a prism and/or another optical aberration of the lens,
characterized in that
the wall portion (1) is formed as a bellows, particularly such that upon actuation of the lens shaping element the radial extension of the container (6) is maintained or at least reduced.

2. The lens (100) according to claim 1, the wall portion (1) comprises a plurality of annular bend portions (3) extending circumferentially in the contour of the wall portion (1) around the wall portion (1), wherein each bend portion (3) comprises a bend of the bellows at which the wall portion (1) can bend in a predefined direction.

3. The lens (100) according to claim 1, wherein the wall portion (1) comprises a plurality of annular folding segments (2) extending between the bend portions (3), wherein adjacent folding segments (2) adopt an angle over the bend.

4. The lens (100) according to claim 3, wherein the folding segments (2) are stiffer than the bending portions (3), particularly such that upon actuation of the lens shaping element the bellows bends only at the bending portions (3), particularly such that upon actuation of the lens shaping element, the angles between folding segments (2) change.

5. The lens (100) according to claim 1, wherein the wall portion (1) comprises fibers that are arranged in an annular fashion circumferentially along the contour of the wall portion (1).

6. The lens (100) according to claim 1, wherein the angles formed by adjacent folding segments (2) alternatingly open toward a side of the container (6) facing the liquid and a side facing away from the liquid.

7. The lens (100) according to claim 2, wherein each bend is formed by at least one recess extending circumferentially around the wall portion (1), particularly wherein the at least one recess locally reduces a wall thickness of the wall portion (1).

8. The lens (100) according to claim 7, wherein a first group of recesses of the plurality of recesses is arranged on a side of the wall portion (1) facing away from the liquid in the container (6), wherein a second group of recesses of the plurality of recesses is arranged on a side of the wall portion facing toward the liquid in the liquid in the container (6).

9. The lens (100) according to claim 8, wherein the recesses from the first group are arranged alternatingly with the recesses of the second group along the contour of the wall portion (1).

10. The lens (100) according to claim 8, wherein the recesses of the first group and the recesses of the second group are arranged at the same position along the contour of the wall portion (1), thereby pairwise forming a bend of the bellows.

11. The lens (100) according to claim 3, wherein the angles formed by adjacent folding segments alternatingly open toward a side of the container (6) facing the liquid and a side facing away from the liquid.

12. The lens (100) according to claim 1, wherein the wall portion (1) comprises a first and a second connecting segment (2a, 2b), wherein the first connecting segment (2a) connects the wall portion (1) with the membrane (4) and the second connecting segment (2b) connects the wall portion (1) with the window element (5), wherein the connecting segments (2a, 2b) are connected via one bend of the bends to a directly adjacent folding segment (2), wherein a first angle enclosed by the first connecting segment and the directly adjacent folding segment opens to the same side as the angle adjacent to said first angle and/or wherein a second angle enclosed by the second connecting segment and a directly adjacent folding segment opens to the same side as the angle adjacent to said second angle.

13. The lens (100) according to claim 3, wherein each folding segment (2) comprises a segment lengths extending along the contour of the wall portion, wherein the segment length of the folding segments (2) is different for different folding segments (2).

14. The lens (100) according to claim 13, wherein adjacent folding segments (22, 23) have pairwise identical length.

15. The lens (100) according to claim 1, wherein a stiffness of the bending portions (3) is different for different bending portions (3), particularly wherein the stiffness is adjusted such that upon actuation of the lens, the bends of the bending portions change by the same amount.

16. The lens (100) according to claim 3, wherein each folding segment (2) comprises segment thickness, wherein the thickness of the folding segments (2) is bigger than the bending portions, particularly a thickness of the wall portion (1) at the recesses.

17. The lens (100) according to claim 1, wherein the wall portion (1) is integrally formed by an elastically deformable compound such as silicone or PDMS.

18. The lens (100) according to claim 1, wherein the thickness of the folding segments (2) is between 300 μm and 700 μm and wherein the thickness of recesses is between 100 μm and 300 μm.

19. The lens (100) according to claim 1, wherein the wall portion (1) has a larger opening on the first side of the container (6) than on the second side of the container (6).

20. The lens (100) according to claim 1, wherein a stiffness of the wall portion (1) along a circumferential direction of the wall portion is higher than a stiffness of the wall portion (1) along an extension direction of the wall portion (1) as well as a stiffness of the wall portion along a radial direction to the wall portion (1).

21. The lens (100) according to claim 1, wherein the lens shaping element can be moved relatively to the window element (5) for adjusting the refractive power of the lens (100), particularly wherein the window element (5) is connected to a housing or fixing member of the lens (100), particularly wherein the lens shaping element is connected to an actuator that is configured to move the lens shaping element relatively to the window element (5).

22. The lens (100) according to claim 1, wherein the window element (5) is a rigid window element, particularly wherein the window element is made of glass or a transparent polymer, particularly wherein the window element (5) comprises a refractive power or wherein the window element is a planar plate-like window element (5) having two planar sides facing towards and away from the liquid, more particularly wherein the window element is a solid lens.

23. The lens (100) according to claim 1, wherein the window element (5) is a second distensible membrane, particularly wherein upon actuation of the lens shaping element said second membrane adjusts its curvature along the optical axis (OA) of the lens (100).

24. The lens (100) according to claim 1, wherein the lens shaping element is elastically deformable at the circumferential aperture along the optical axis, particularly such that aberrations can be compensated by locally adjusting an axial position of the lens shaping element along its circumferential aperture.
